(19) United States
(12) Patent Application Publication
(10) Pub. No.: US 2005/0274463 A1
(43) Pub. Date: Dec. 15, 2005

(54) Pet door and method of operation

(76) Inventor: Kent Becker, Huntertown, IN (US)

Correspondence Address: TAYLOR & AUST, P.C., 142 SOUTH MAIN STREET, P. O. BOX 560, AVILLA, IN, 46710, US

(21) Appl. No.: 11/152,282

(22) Filed: Jun. 14, 2005

Related U.S. Application Data
(60) Provisional application No. 60/579,743, filed on Jun. 15, 2004.

(51) Int. Cl. E06B 7/28

(52) U.S. Cl. 160/98

(57) ABSTRACT

A pet door system including a door, a detection device, a receiver, a motor and a controller. The detection device detects the proximate presence of a pet to the door. The receiver receives an identification signal that establishes an identity of the pet. The motor is operatively connected to the door. The controller is communicatively coupled to the detection device, to the receiver and to the motor. The controller issues a signal to the motor to open the door based upon the identity of the pet.

### CROSS REFERENCE TO RELATED APPLICATIONS

This is a non-provisional application based upon U.S. provisional patent application Ser. No. 60/579,743, entitled “PET DOOR”, filed Jun. 15, 2004.

### BACKGROUND OF THE INVENTION

1. Field of the Invention

The present invention relates to a pet entrance door, and, more particularly, to an automated pet entrance door.

2. Description of the Related Art

Pet doors are known in the art, which include flexible flaps over an opening in a wall or door to allow a pet to have access to a house. The pet normally presses against the flexible flap allowing the pet to displace the flap and enter the house. The flap is non-insulated and can be very uneconomical during inclement weather. This sort of pet door offers little or no security, allowing other animals or even people to have access to the home.

Pet doors available on the market today often consist of a soft plastic or aluminum material, which hang by gravity, typically in a swinging manner and are sealed by a magnetic device. Other doors have an overlapping of plastic material in such a way as to prevent excessive weather penetration. These sorts of pet doors operate by way of the pet having to push against the door or flap with its head in order to enter or exit.

Automatic opening doors for pets are also known, which lock when closed to prevent unauthorized access into a home.

What is needed in the art is a pet door that controls access yet reduces the amount of air that enters or exits the home.

### SUMMARY OF THE INVENTION

The present invention provides a pet door that retracts based upon identification of the pet.

The invention comprises, in one form thereof, a pet door system including a door, a detection device, a receiver, a motor and a controller. The detection device detects the proximate presence of a pet to the door. The receiver receives an identification signal that establishes an identity of the pet. The motor is operatively connected to the door. The controller is communicatively coupled to the detection device, to the receiver and to the motor. The controller issues a signal to the motor to open the door based upon the identity of the pet.

An advantage of the present invention is that the pet door is opened based upon the identification of an approaching animal.

Another advantage of the present invention is that the system easily learns the identification of a new pet.

Another advantage of the present invention is that controllable entry of the pet is maintained on a scheduled basis.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a front view of an embodiment of the pet door of the present invention;

FIG. 2 is a partially sectioned side view of the pet door of FIG. 1;

FIG. 3 illustrates, in a cross-sectional manner, a portion of the upper part of the pet door of FIGS. 1 and 2;

FIG. 4 is another view of FIG. 3 with the door retracted;

FIG. 5 illustrates the installation of the pet door of FIGS. 1-4 in a residential door;

FIG. 6 illustrates an embodiment of a method of operation of the pet door of FIGS. 1-5;

FIG. 7 is a continuation of the method of FIG. 6; and

FIG. 8 is an embodiment of a method to confirm the identification of a pet proximate to the pet door of FIGS. 1-5.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

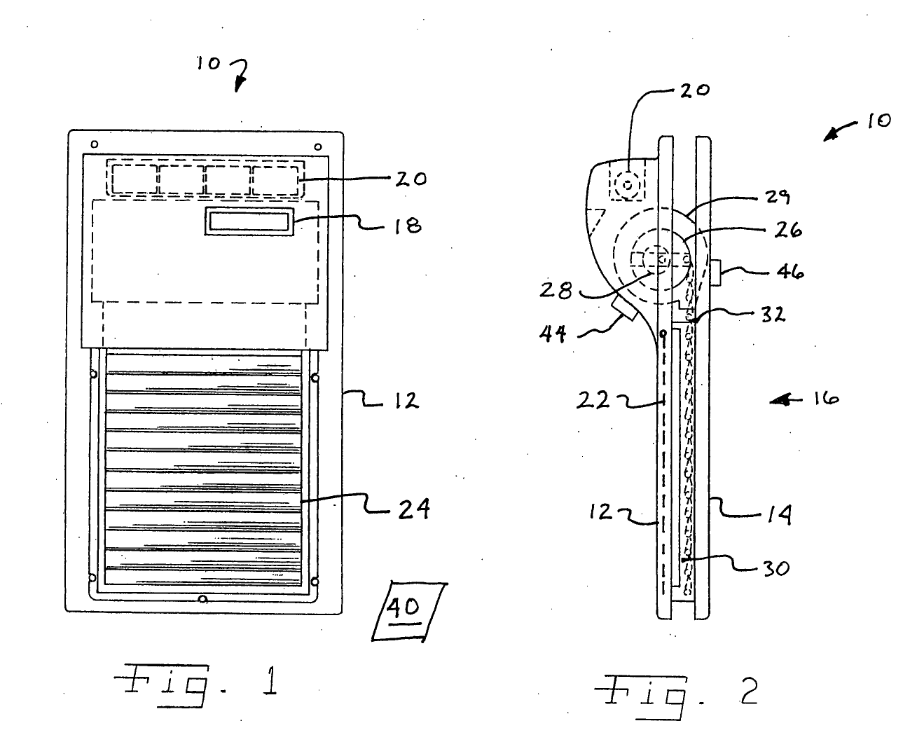

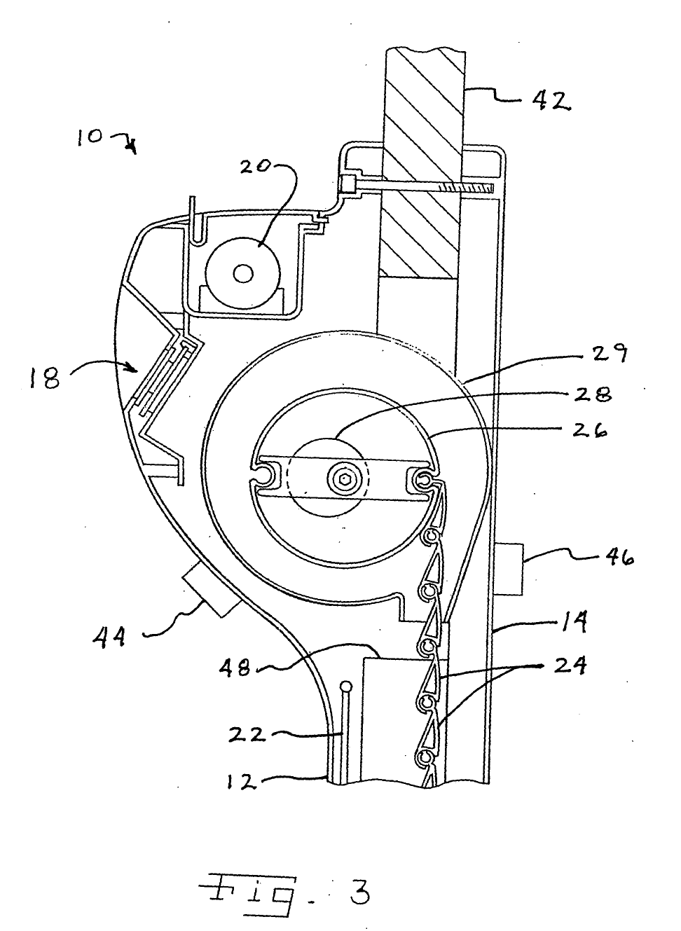

Referring now to the drawings, and, more particularly to FIGS. 1 and 2 there is shown a pet door assembly 10 including an inner frame 12, an outer frame 14, a door assembly 16, a control assembly 18, a power source 20 and a door flap 22. Inner frame 12 and outer frame 14 are mounted on opposite sides of a door or wall and extend beyond the opening therein. Inner frame 12 and outer frame 14 are fastened together through the intervening structure by way of screws or other fasteners that go through the opening in the wall or door, without the need to drill additional holes in the wall or door.

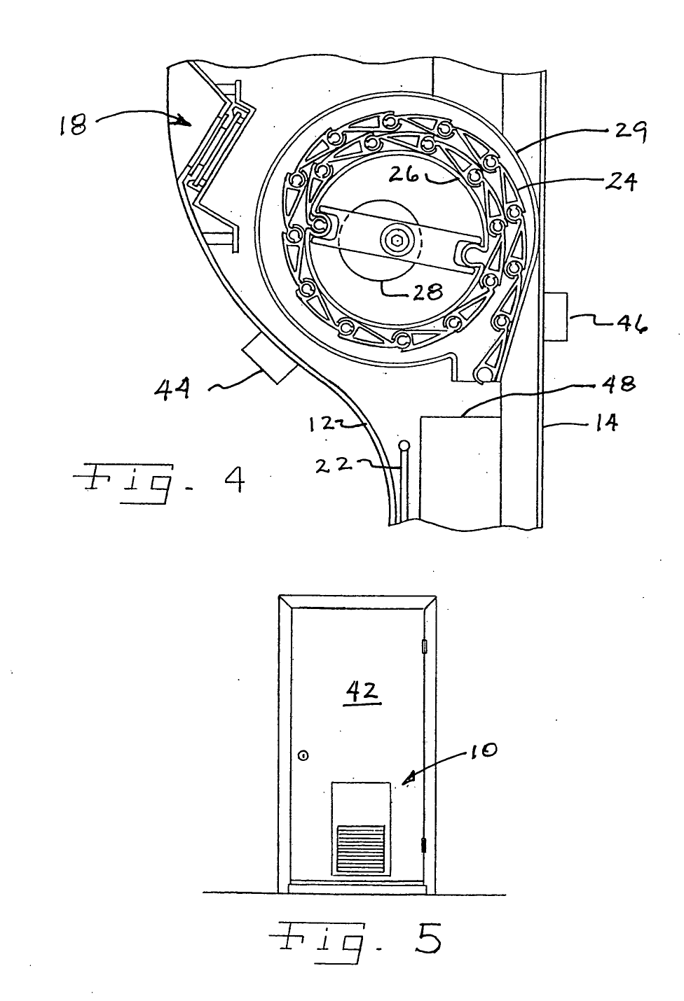

Door assembly 16 is a segmented door 16 including slats 24, a roller tube 26, a motor 28, a slat scroll 29, tracks 30, and a brush seal 32. Slats 24 are linked together in a rolling manner along the edges of each slat 24. Slats 24 are segments that are interconnected yet are able to be wound around roller tube 26. As shown in FIGS. 3 and 4, slats 24 have a cross sectional shape with a hollow interior defining a thermally insulative air gap. Motor 28 is connected to roller tube 26, which supplies power for the rotation of roller tube 26 to thereby wind slats 24 therearound when door assembly 16 is in an open position. Slat scroll 29 guides slats 24, particularly when they unwind from roller tube 26, by directing slats 24 toward tracks 30. Tracks 30 on each side of frames 12 and 14 allow slats 24 to be retained in a substantially vertical manner as door assembly 16 moves slats 24. A brush seal 32 is located along a proportion of outer door frame 14 to seal the mechanism of door assembly 16, to thereby exclude insects and the of air therethrough.

Control assembly 18 includes an operator interface panel allowing an operator to energize the control circuits of assembly 10 and to designate which transmitters 40 will function with assembly 10. Control assembly 18 can also select the amount of time that door assembly 16 is in an open position and the proximity of transmitter 40 to which control assembly 18 should respond. Further, control assembly 18 can be utilized to establish a schedule as to when a transmitter 40 will or will not trigger the opening of door assembly 16 when transmitter 40 is proximate to door assembly 10. Control assembly 18 includes an interface to communicate with a home security system so that the home security system can use information from control assembly 18 to sound a chime indicating that door assembly 16 is open, or to alter the type of detection features the security system utilizes if the door is open or closed, and even to indicate that all of the pets are outside. Additionally, if door assembly 16 is breached by a person trying to enter the house this information is passed along to the home security system. The interface also allows the security system to provide information to control assembly 18 to allow it to alter its operations. For example, if a fire is detected by the security system, then door assembly 16 will only open if a pet wants out and will not allow a pet to enter the house. Also, if the security system detects movement, which may indicate an unauthorized person in the house, control assembly 18 may allow certain pets to leave and others, such as a guard dog, to enter the house.

Power source 20 includes batteries, which provide a DC power source to power motor 28 under the control of control assembly 18. Additionally, an AC power source may be utilized to provide power to pet door assembly 10.

Flexible door flap 22 is positioned along one side of door assembly 16 to provide a further barrier for the movement of air through an opening in assembly 10. When a pet wearing transmitter 40 approaches pet door assembly 10 and door assembly 16 is open, door flap 22 reduces the air movement through the opening until the pet passes through the opening. Door flap 22 may be removable.

Transmitter 40 is worn on a pet, preferably on a pet collar, and provides an identification signal, in the form of a keyed transmission, which is detected by door assembly 10 and decoded by control assembly 18 to decide whether or not to open door assembly 16, thereby providing a keyed entry system. A plurality of transmitters 40 may be utilized with control assembly 18 containing information as to which transmitters 40 are to effect the opening of door slats 24.

Assembly 10 can also be thought of as a security shutter 16 that automatically opens and closes when a pet approaches to allow access to an outside or an inside area. Soft flap 22 adds additional protection from the elements while shutter 16 remains open. Shutter 16 provides security, insulation and a weather-proof seal. Control assembly 18 includes circuitry, software and an operator interface, for optical, radio frequency or an RFID interface. The software is used to identify the Identification of the pet and to determine if and when to open and close shutter 16.

The activation of door assembly 10 is accomplished by way of transmitter 40 or an RFID added to a pet's existing collar. Assembly 10 receives a signal from transmitter 40 when the pet is within a preset range, typically 16-36 inches, and the door opens by the activation of motor 28. Motor 28 causes roller tube 26 to rotate, onto which slatted door assembly 16 is wound and unwound. Door assembly 16 remains in an open position for up to five seconds after transmitter 40 is out of range. The user can adjust the range and timing of the door opening by way of control assembly 18. Control assembly 18 may additionally include a battery life indicator.

If transmitter 40 transmits an RF signal, a replaceable battery will be utilized to supply power to transmitter unit 40 on the pet's collar. Alternatively, RFID technology can be utilized to provide identity information relative to the particular pet approaching door assembly 10.

Software within control assembly 18 monitors the battery voltage and when the battery voltage drops to a certain level, the door will not activate to the rollup position. This safety feature prevents the door from remaining in an open position due to a low battery condition. The battery life indicator informs the user of the low battery condition. Additionally, a light curtain or IR screen will sense obstruction in the opening to prevent door assembly 16 from closing if an obstruction is in the opening. Additionally, if the door assembly should contact an item preventing complete closure of the door, the door assembly will reverse to the open position and sound an alarm until the obstruction is removed.

Now, additionally referring to FIGS. 3 and 4, there is shown, in FIG. 3, a view of slats 24 in an extended closed position, and slats 24 are wound onto tube 26 when door assembly 16 is in an open position as shown in FIG. 4.

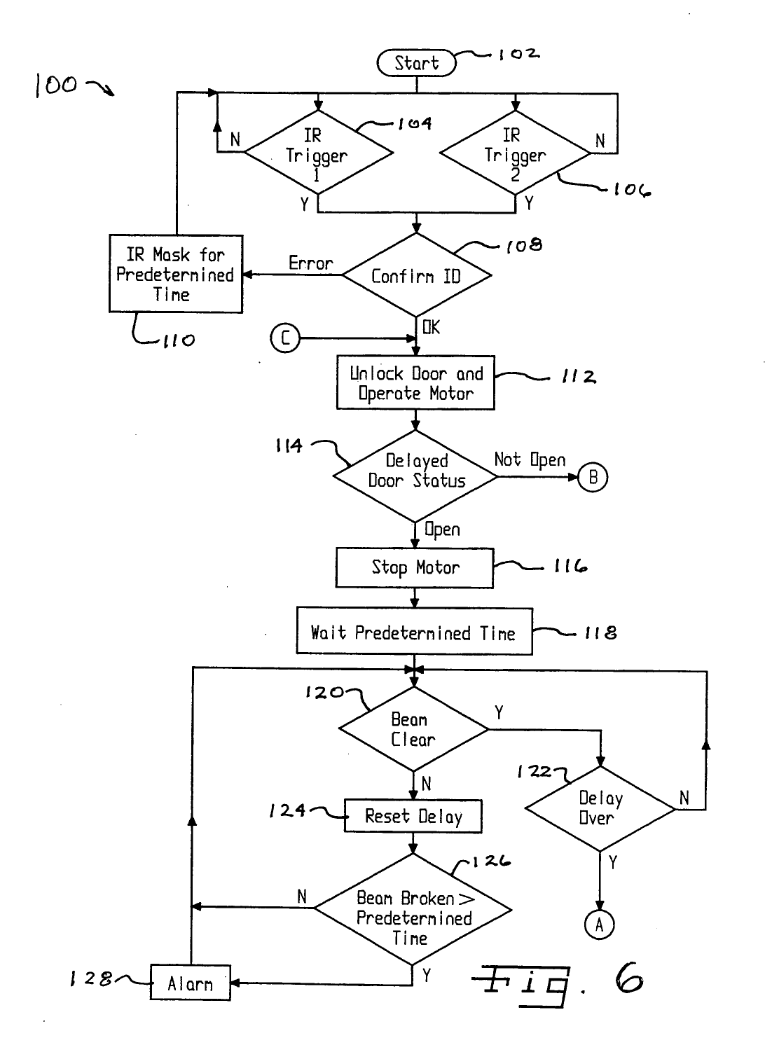

Now, additionally referring to FIG. 5 there is shown a view of door assembly 10 installed in a residential door 42. The advantage of installing door assembly 10 in residential door 42 is that access on both sides of door 42 is normally maintained so that the pet can approach from either side without difficulty.

Electronic device assemblies 44 and 46 include a passive detection device, suitable for detecting the presence of a pet, such as, an infrared motion detection device. Also contained within assemblies 44 and 46 is a receiver and transmitter used to query transmitter 40. Transmitter 40 may be an RFID device, which responds to a level of impinged electromagnetic radiation and may be considered a transponder 40. The passive detection devices in assemblies 44 and 46 detect the presence of an animal, then the transmitter in the respective assembly 44 or 46 sends a signal or radio frequency power signal, which can cause an RFID device to function. The RFID device may be attached to a collar on the pet or subcutaneously located just beneath the skin of the pet. Transponder 40 returns a signal that is received by the receiver in assembly 44 or 46. The signal contains an identification of the device that is associated with a particular pet. The pet is identified as one being allowed to enter or exit the home and a determination is made by control assembly 18 as to whether the pet is blocked from exiting or entering the home based on other criteria such as a timing schedule associated with when the pet can enter or exit the home. Motor 28 is activated by way of a signal from control assembly 18 causing slats 24 of door assembly 16 to be wound upon roller 26 to allow movement of the pet through the doorway.

Electronic assembly 44 and/or 46 may include a passive infrared device (PIR) and/or an RFID antenna that has a magnetic tuning mechanism. The mechanism uses a magnet to alter the permeability of an inductor core in order to alter the value of the inductor for tuning purposes. The magnetic tuning method provides at least a 5:1 change in inductance, which is over 20 times more range than can be done with a low loss pot core. This range of tuning allows a lot of variation in the methods of antenna construction and mounting techniques. The mechanism allows for the tuning mechanism to be cast into the plastic of frame 12 and/or 14 and allow the positioning of the in terminals of the inductor to be positioned on a printed circuit board.

Transponder 40 contains an electronic ID, which must be recognized by the electronics in control assembly 18 as belonging to a pet authorized to open door assembly 16. Control assembly 18 may be programmed to accept multiple pet IDs and to specify the allowable entry/exit patterns for each individual pet. The entry/exit pattern for each pet may each relate to numerous variables such as the day of the week, the time of day, the temperature, the weather conditions and/or the number of uses of the door in a specific time period.

As the pet enters through the door opening, a transition detection device 48, which may be in the form of an ultrasonic detector 48 or an infrared light curtain 48, detects the presence of the pet as it is transiting the doorway and provides this information to control assembly 18 to prevent door assembly 16 from closing on the pet. Once the pet has transited the doorway, door assembly 16 is closed by operation of motor 28 unrolling slats 24 from roller 26, thereby closing retractable door assembly 16. If the pet approaches pet door assembly 10 and door assembly 16 is opened but the pet does not enter through the passageway after a predetermined time, door assembly 16 is closed.

Now, additionally referring to FIGS. 6-8, there are illustrated embodiments of methods to operate pet door assembly 10. In particular, a method 100 which illustrates the control of door assembly 16 exerted by control assembly 18 and method 200 illustrates a method of confirming the identification of the pet. Method 100 starts at step 102 and proceeds to either step 104 or 106. Steps 104 and 106 are substantially similar and step 104 corresponds to the detection of an infrared signal by an infrared detector in electronic assembly 44 and step 106 corresponds to the detection of an infrared signal by an infrared detector in electronic assembly 46. If either the infrared detector in assembly 44 or 46 are triggered, then the respective step 104 or 106 proceeds to step 108. At step 108 a confirm ID method is executed, which will be explained later as method 200. As a result of executing step 108 a result is returned from method 200, which indicates that an ID is confirmed or an error signal is returned. If an error signal is received then the method proceeds to step 110 and the infrared signals from electronic assemblies 44 and/or 46 are masked for a predetermined time. This predetermined time is selected so as to prevent a pet from repeatedly triggering control assembly 18 to open door assembly 16. Once the predetermined time has expired, the method returns to steps 104 and 106.

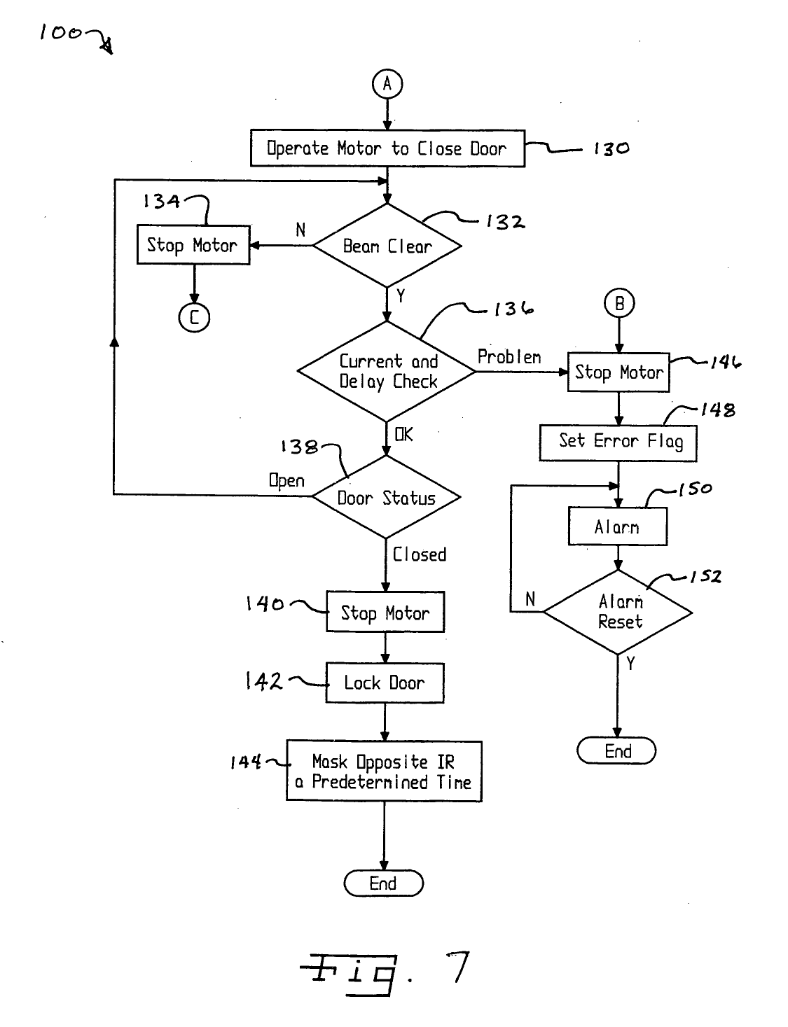

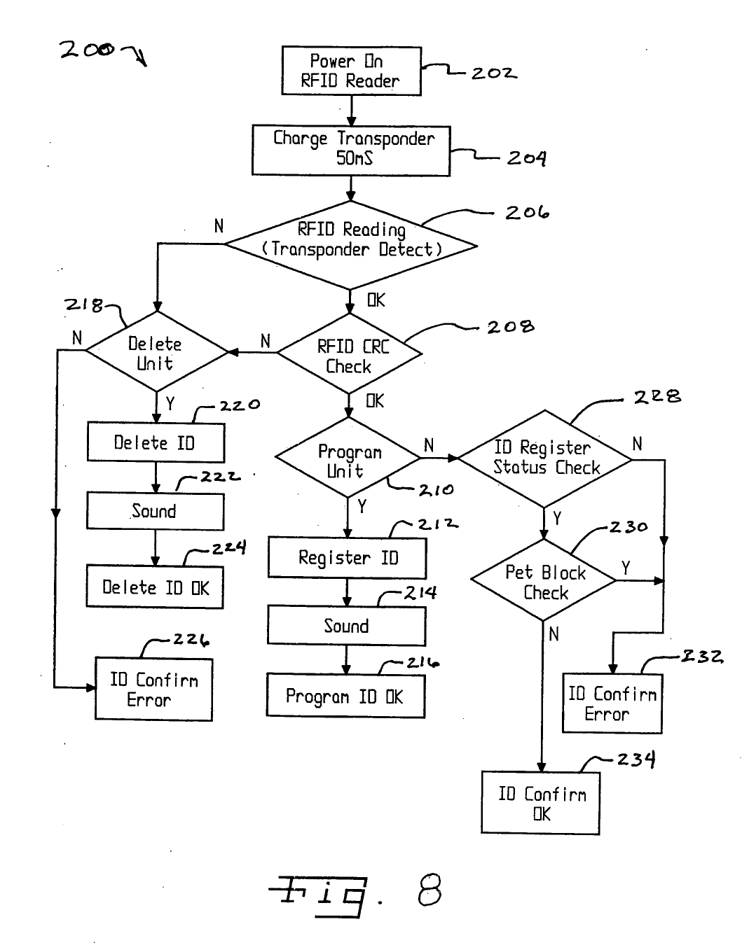

If a confirmed ID signal is returned, at step 108 then door assembly 16 is unlocked and a signal is sent to motor 28 to open door assembly 16, at step 112. A delayed door status is determined, which is a determination of the status of the door after a predetermined time and if the door is not open method 100 proceeds to point B in FIG. 7. If the delay door status, at step 114 indicates that door 16 is open then motor 28 is stopped, at step 116. After another predetermined time, as indicated at step 118, is waited then it is determined if light curtain 48 indicates that the light beam is clear, which indicates that the doorway is free of obstructions and then a short delay is waited to ensure clearance of the pet through the doorway at step 122. Once the delay is completed the method continues to point A in FIG. 7. If the delay is not over the method returns to step 120 to again determine if light curtain 48 indicates a clear doorway. If at step 120 the beam of light curtain 48 is not clear then a delay is reset at step 124. If the beam of light curtain 48 is broken greater than a predetermined time then an alarm, at step 128 is sounded to motivate the pet to move one way or the other. The alarm can also alert the homeowner that the door has been opened greater than a predetermined time and that something is blocking the doorway. If the beam has not been broken for greater than predetermined time then the process returns to step 120.

Once the delay is over at step 122 motor 28 is operated to close the door, at step 130. If something acts to disrupt light curtain 48, at step 132 then motor 28 is stopped at step 134. The method then returns to step 112 on FIG. 6. If the beam of light curtain 48 remains clear then there is a current and delay check that is undertaken, at step 136. A current check of the power being supplied to motor 28 is done to indicate if a load on the motor exceeds that required for normal operation. If the current being drawn by motor 28 exceeds a predetermined amount, it may be indicative of a problem in closing door assembly 16 or that something is blocking the closing of door 16. Also if the closing of door 28 takes longer than a predetermined time, this may also indicate a problem. As such, either indicator of a problem causes the motor to stop at step 146. An error flag is set in control assembly 18, at step 148 and an alarm is sounded at step 150. The alarm remains on until the alarm is reset, at step 152 and method 100 is completed and is restarted back at starting point 102.

If the current and delay check indicates that pet door assembly 10 is O.K. then door status sensors (not shown) are checked at step 148 to determine if door assembly 16 is open or closed.

If door assembly 16 is open the method returns to step 132 and if the door status indicates that the door is closed then motor 28 is stopped at step 140. Once motor 28 is stopped door assembly 16 is locked, at step 142. Once a pet enters or exits the home it may quickly decide to return;

however, at step 144 the opposite infrared detector in electronic assembly 44 or 46, which is opposite the one utilized to open the door in the most recent opening is masked a predetermined time, to prevent the pet from reinitiating the opening of door assembly 16. The predetermined time can be selected at control assembly 18 and can be separately assigned for each side of the door. For example, if it is desirable to let the pet always exit at any time then the predetermined time for the infrared mask associated with electronic assembly 44 (the one on the inside of the home) would be minimized or even set to zero. However, the predetermined time associated with the mask for electronic assembly 46 may be set for a much longer time, such as one minute. In this way the pet can exit at any time but is not allowed to return for at least one minute after going outside. After the predetermined time, method 100 ends and restarts at starting point 102.

In FIG. 8 there is illustrated a method of determining the identification of the pet, including steps 202 through 234. It will be understood that when the ID confirm error signal is generated at steps 226 or 232 that is the signal that is returned as an error in method 100 at step 108. Conversely, when the ID is confirmed, such as at steps 216 and 234 then an O.K. signal is returned to step 108 of method 100.

Although an RFID transponder 40 is illustrated in method 200, the technique can be easily adapted to an RF receiver transmitter 40. At step 202 an RFID reader in either assembly 44 or 46 is powered on in order to ready the reader to receive a signal from transponder 40 associated with the pet. A transmission is sent to transponder 40 which will either serve to power the transponder 40 and/or cause it to send an identification signal to be read by the RFID reader. Once transponder 40 has been charged for a short period of time such as 50 milliseconds, at step 204 a signal, that contains an identification code (ID) of transponder 40, is sent to electronic assembly 44 or 46. If, at step 206, an RFID reading is detected then the RFID CRC is checked at step 208. If the CRC indicates that the RFID was not of an acceptable format or indicates an error in the signal then if the detected identification code is to be deleted at step 218 the process continues to step 220. If the unit is not to be deleted at 218 then an ID confirm error is sent from method 200 at step 226.

If it is indicated that transponder 40 is to be deleted then the identification code that is contained in the acceptable list of identifications in control assembly 18 is deleted at step 220 and a sound issued at step 222. If the operator indicates that it is O.K. to delete the identification code, at step 224, then the identification code is deleted from the acceptable list and method 200 ends.

If the check of the RFID format, at step 208 indicates that the RFID is of a proper format then if there is an indication in control assembly 18 that places control assembly 18 in a programming mode, so as to incorporate a new pet identification code into the acceptable list of pets that may enter through door assembly 16, then the ID is registered at step 212 and a sound is issued at step 214 to indicate its acceptance as a newly programmed ID and an O.K. is issued at step 216, which also returns an O.K. to method 100 at step 108 and method 100 proceeds to unlock and open the door. If there is no indication on control assembly 18 that the unit is being programmed then, at step 210, method 200 proceeds to check the ID received from transponder 40 against a list of acceptable IDs, at step 228. If the pet is not authorized to enter the home then method 200 proceeds to step 232 and returns an ID confirm error to method 100. An additional check is made at step 230 to determine if the pet has been temporarily blocked from entering the home. In other words the pet may have an acceptable ID to normally operate the door assembly 16, but is currently being blocked from activating the door. A pet may be temporarily blocked from leaving the home even though the pet ID is included as one authorized to enter or exit, which may be due to a scheduling sequence in control assembly 18. For example, the pet may be allowed to enter the home in the evening hours but will not be allowed to leave until a certain time in the morning. If there is no blocking of the pet ID, then method 200 returns an ID confirm O.K. at step 234.

Advantageously, the methods of the present invention has a learning mode where IDs may be entered to allow pets to pass through the doorway. This learning mode allows the RFID system to query a proximate RFID device to obtain the ID therefrom, which is then entered into the list of acceptable IDs. Also, the scheduling of the access of the pet is controlled. The present invention also takes advantage of RFID systems for the identification of the pet.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A pet door system, comprising:
a door;
a detection device that detects a proximate presence of a pet to said door;
a receiver to receive an identification signal that establishes an identity of the pet;
a motor operatively connected to said door; and
a controller communicatively coupled to said detection device, to said receiver and to said motor, said controller issuing a signal to said motor to open said door based on said identity.

2. The pet door system of claim 1, wherein said door is retractable.

3. The pet door system of claim 2, wherein said door includes a plurality of slats each pivotally interconnected with an adjacent one of said plurality of slats.

4. The pet door system of claim 1, further comprising:
a responding device one of located on the pet and subcutaneously located in the pet; and
a transmitter communicatively coupled to said controller, said transmitter sending a signal to said responding device.

5. The pet door system of claim 4, wherein said responding device is a radio frequency receiver and transmitter.

6. The pet door system of claim 4, wherein said responding device is an RFID device.

7. The pet door system of claim 4, wherein said responding device is located subcutaneously in the pet.

8. The pet door system of claim 1, further comprising a transition detection device communicatively coupled to said controller, said door revealing a passageway when said door is opened, said transition detection device detecting whether the pet is in said passageway and conveying information to said controller as to whether the pet is one of in and not in said passageway.

9. The pet door system of claim 1, wherein said detection device includes at least one of an RFID apparatus and a PIR apparatus.

10. A door assembly, comprising:
an entryway door; and
a pet door installed in a lower portion of said entryway door, said pet door including:
a segmented door;
a detection device that detects a proximate presence of a pet to said segmented door;
a receiver to receive an identification signal that establishes an identity of the pet;
a motor operatively connected to said segmented door; and
a controller communicatively coupled to said detection device, to said receiver and to said motor, said controller issuing a signal to said motor to open said door based on said identity.

11. The door assembly of claim 10, wherein said segmented door is retractable.

12. The door assembly of claim 11, wherein said segmented door includes a plurality of slats each pivotally interconnected with an adjacent one of said plurality of slats.

13. The door assembly of claim 10, further comprising:
a responding device one of located on the pet and subcutaneously located in the pet; and
a transmitter communicatively coupled to said controller, said transmitter sending a signal to said responding device.

14. The door assembly of claim 13, wherein said responding device is a radio frequency receiver and transmitter.

15. The door assembly of claim 13, wherein said responding device is an RFID device.

16. The door assembly of claim 13, wherein said responding device is located subcutaneously in the pet.

17. A method of operating a pet door, comprising the steps of:
detecting the presence of a pet;
obtaining an identity signal from a responding device that is one of attached to the pet and implanted in the pet; and
opening the pet door based on a match of said identity signal with a corresponding entry in a list of authorized identity signals.

18. The method of claim 17, further comprising the step of closing the pet door once the pet has transited the pet door.

19. The method of claim 17, further comprising the step of closing the pet door if the pet does not enter the pet door within a predetermined time.

20. The method of claim 17, further comprising the step of detecting a presence of the pet in a passageway of the pet door.

21. The method of claim 17, further comprising the step of indicating an acceptance of a new identity signal from another responding device associated with another pet.

22. The method of claim 17, wherein said responding device is an RFID device.

23. The method of claim 17, wherein said detecting step and said obtaining step each use at least a part of a dual detection device including a first detection device and a second detection device, said first detection device carrying out said detecting step, said second detection device carrying out said obtaining step.

24. The method of claim 23, wherein said first detection device is a passive detector, said second detection device being an active detector.

25. The method of claim 17, further comprising the step of enforcing an entry/exit pattern for the pet that determines whether or not the pet door will operate for the pet based on a set of predetermined criteria.

26. The method of claim 25, wherein said predetermined criteria include at least one of a time of day and a number of operations of the pet door for the pet in a predetermined time period.

27. The method of claim 25, wherein another pet has an other set of predetermined criteria.

28. The method of claim 17, further comprising the step of inhibiting opening of the pet door if a battery sensor indicates that a battery has insufficient energy to open and close the pet door.

29. The method of claim 17, further comprising the step of learning an additional identity signal from a transponder device and adding said additional identity signal to said list of authorized identity signals.
